(19) United States
(12) Patent Application Publication
(10) Pub. No.: US 2010/0075619 A1
(43) Pub. Date: Mar. 25, 2010

(54) HARD HAT WITH RADIO FREQUENCY COMMUNICATION

(76) Inventors: Jordan Lowell Solla, Bellevue, WA (US); Dale James Beard, Seattle, WA (US)

Correspondence Address: DAVIS & BUJOLD, P.L.L.C., 112 PLEASANT STREET, CONCORD, NH, 03301, US

(21) Appl. No.: 12/272,077

(22) Filed: Nov. 17, 2008

Related U.S. Application Data
(60) Provisional application No. 60/988,454, filed on Nov. 16, 2007.

(51) Int. Cl. H04B 1/38; A42B 1/06; A42B 1/24

(52) U.S. Cl. 455/90.3; 2/410; 2/209.13

(57) ABSTRACT

A hard hat with radio frequency communication includes a hat body and a vibrator carried by the hat body. A transceiver for receiving and transmitting radio frequency signals is connected to a processor. The transceiver and the processor are carried by the hat body. The processor is programmed to activate the vibrator to notify a wearer of a radio frequency signal received by the transceiver and to transmit an acknowledgement signal via the transceiver. A power source is carried by the hard hat for powering the vibrator, the transceiver and the processor.

### FIELD

Hard hats with radio frequency communication capability.

### BACKGROUND

On a construction site, it is sometimes difficult to communicate with all workers. Two-way radios are an option, but supplying each worker with one can be expensive.

### SUMMARY

According to an aspect, there is provided a hard hat with radio frequency communication comprising a hat body and a vibrator carried by the hat body. A transceiver for receiving and transmitting radio frequency signals is connected to a processor. The transceiver and the processor are carried by the hat body. The processor is programmed to activate the vibrator to notify a wearer of a radio frequency signal received by the transceiver and to transmit an acknowledgement signal via the transceiver. A power source is carried by the hard hat for powering the vibrator, the transceiver and the processor.

According to an aspect, there is provided a system for notifying individuals on a construction site. The system comprises at least one fixed transceiver for transmitting and receiving signals, and more than one hard hat with radio frequency communication. Each hard hat comprises a hat body, a vibrator carried by the hat body, and a mobile transceiver for receiving and transmitting radio frequency signals to and from the general transceiver connected to a processor. The mobile transceiver and the processor are carried by the hat body. The processor is programmed to activate the vibrator to notify a wearer of a radio frequency signal received by the mobile transceiver and to transmit an acknowledgement signal via the mobile transceiver to the general transceiver. A power source is carried by the hard hat for powering the vibrator, the mobile transceiver and the processor.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a hard had with a partial cutaway.

FIG. 2 is a schematic view of a worksite.

### DETAILED DESCRIPTION

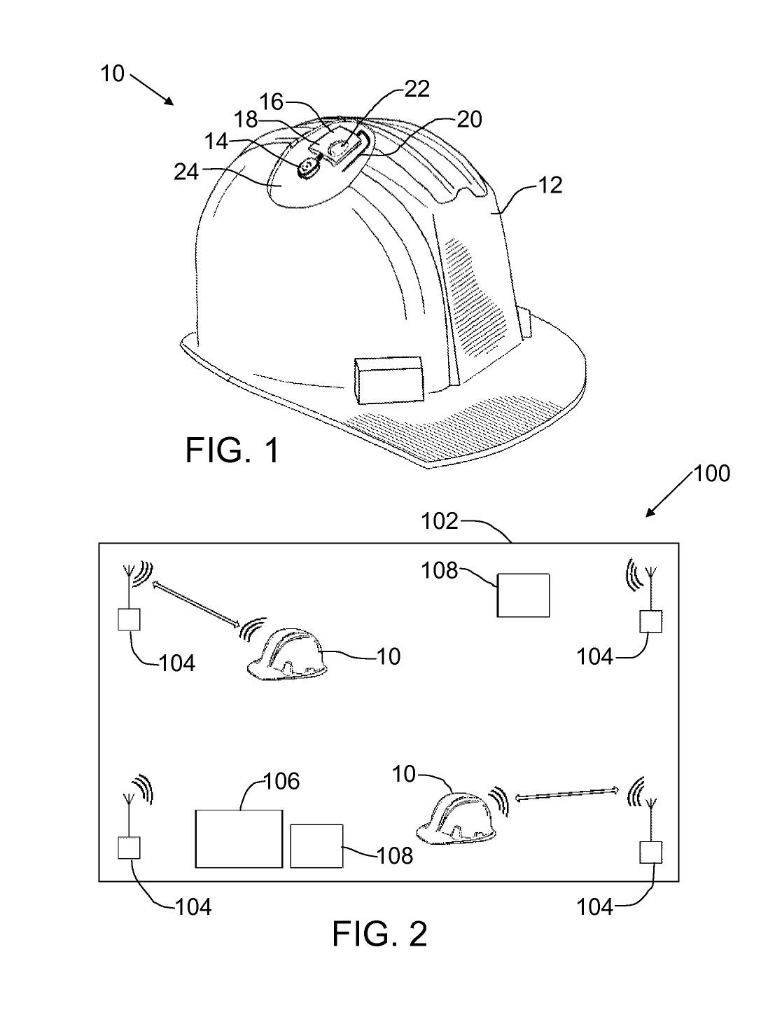

A hard hat with radio frequency communication generally identified by reference numeral 10 will now be described with reference to FIG. 1. A system using the hard hats generally identified by reference numeral 100 will then be described with reference to FIG. 2

Structure and Relationship of Parts of hard hat 10:

Referring to FIG. 1, hard hat 10 includes a hat body 12, a vibrator 14 carried by hat body 12 and a transceiver 16 for receiving and transmitting radio frequency signals. Transceiver 16 is connected to a processor 18, which may be integrally formed with transceiver 16 as shown, or it may be integrally formed with vibrator 14. Transceiver 16 and processor 18 are both carried by hat body 12. Transceiver 16 includes an antenna 20 that it uses to receive and transmit radio frequency signals. Processor 18 is programmed to activate vibrator 14 to notify a wearer when a radio frequency signal is received by transceiver 16. Processor 18 also transmits an acknowledgement signal via transceiver 16. A power source 22 is also carried by hard hat body 12 for powering vibrator 14, transceiver 16 and processor 18.

In a preferred embodiment, vibrator 14 generates different vibration patterns for different radio frequency signals received by transceiver 16, for example by programming processor 18 to activate and deactivate vibrator 14 at predetermined intervals. The various signals may indicate a scheduled break, notification of an emergency situation, etc.

In order to remain cost effective, hard hats 10 are specifically designed to have a minimum amount of communication and notification equipment.

As depicted, vibrator 14, transceiver 16, processor 18 and power source 22 are carried in a cavity 24 integrally formed or embedded in hard hat 10. Preferably, a removable cover is provided (not shown) to allow power source 22 to be replaced when needed. As depicted, power source 22 may be a battery, or possibly a solar panel (not shown).

Structure and Relationship of Parts of system 100:

Referring to FIG. 2, hard hat 10 as described above may be used in system 100 to allow supervisors or managers to send selected signals to individuals on a work site 102. System 100 one or more fixed transceivers 104, depending on the size of work site 102 and the power of fixed transceivers 104 or mobile transceivers 16, for transmitting notification signals, and receiving acknowledgement signals with mobile transceivers in hard hats 10.

System 100 has two main components: (1) the embedded radio frequency identification tag, or mobile transceiver 16, batteries 22, antenna 20 and vibration motor 14 within hard hat 10 as shown in FIG. 1 and (2) the radio frequency identification readers, or fixed transceivers 104. Fixed transceivers 104 are installed around project site 102 to cover the entire site with RF communications between mobile tags 16 and fixed readers 104.

In a preferred embodiment, each hard hat 10 would have a unique identifier or a radio frequency identification tag. This would allow a computer controller in the main office 106 to determine which hard hats 10 have not reported in, and presumably, which hard hats 10 have not yet received the signal. This would either indicate a worker that was off site, or a defective hard hat.

In addition to allowing the main office 106 to determine which hard hats 10 have received the signal, it would also allow the main office 106 to notify certain individuals, or a certain class of individuals.

Many different types of signals may be used, such as to indicate a scheduled break the end of the work period or break, an emergency situation, or other message, such as an indication to move to the nearest muster point 108. Each message would correspond to a specific vibration pattern that would be transmitted through hard hat 10. The vibrations may continue for a predetermined period of time, or there may be a reset switch (not shown) to stop the vibrations. If a reset switch is used, activating the switch may also activate the acknowledgement signal.

### Advantages:

Using radio frequency identification tags in construction hard hats 10, communication with the construction workers spread out over large construction sites 102 provides a relatively simple and cost effective solution as compared to giving each worker cellular phones or long range two-way communication devices. With every worker wearing a hard hat while on any construction site, the radio frequency identification enabled hard hat 10 sends the worker messages by vibrations in their hard hat 10. There are many advantages to being able to communicate with workers in a construction site including (1) notifying workers of events like break time and lunch, (2) alerting workers for safety reasons to direct them to meet at the closest muster point and (3) alerting individuals if they are needed to return to the main office.

By embedding a radio frequency tag in a construction hard hat 10, many of the site-wide communication problems can be overcome. For example, the worker can be contacted instantaneously when anywhere on the construction site. If communication can't be made with the worker (even after several attempts to locate the radio frequency identification tag in the hard hat have been made), then the system may show the worker as unavailable, or as being located off-site.

Using a hard hat to relay communication signals to workers includes advantages such as (1) a cost-effective solution, (2) it doesn't add additional items to the worker's tools, i.e. the hard hat is already mandatory gear for every worker, (3) it provides immediate access to the worker for emergencies

The radio frequency tag with vibration functionality also provides a relatively simple means of communication with the worker. Based on the types of messages the construction offices want to relay to the workers, simple vibration patterns can be used to transmit different types of messages.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A hard hat with radio frequency communication, comprising:
a hat body;
a vibrator carried by the hat body;
a transceiver for receiving and transmitting radio frequency signals connected to a processor, the transceiver and the processor being carried by the hat body, wherein the processor is programmed to activate the vibrator to notify a wearer of a radio frequency signal received by the transceiver and to transmit an acknowledgement signal via the transceiver; and
a power source carried by the hard hat for powering the vibrator, the transceiver and the processor.

2. The hard hat of claim 1, wherein the processor is integrally formed with one of the transceiver and the vibrator.

3. The hard hat of claim 1, wherein the vibrator generates different vibration patterns for different radio frequency signals received by the transceiver.

4. The hard hat of claim 1, wherein the vibrator, the transceiver, the processor and the power source are carried in a cavity integrally formed in the hard hat.

5. A system for notifying individuals on a construction site, comprising:
at least one fixed transceiver for transmitting and receiving signals; and
more than one hard hat with radio frequency communication, each hard hat comprising:
a hat body;
a vibrator carried by the hat body;
a mobile transceiver for receiving and transmitting radio frequency signals to and from the general transceiver connected to a processor, the mobile transceiver and the processor being carried by the hat body, wherein the processor is programmed to activate the vibrator to notify a wearer of a radio frequency signal received by the mobile transceiver and to transmit an acknowledgement signal via the mobile transceiver to the general transceiver; and
a power source carried by the hard hat for powering the vibrator, the mobile transceiver and the processor.

6. The system of claim 5, wherein each hard hat generates a unique acknowledgement signal.

7. The system of claim 5, wherein the processor is integrally formed with one of the transceiver and the vibrator.

8. The system of claim 5, wherein the vibrator generates different vibration patterns for different radio frequency signals received by the transceiver.

9. The system of claim 5, wherein the vibrator, the transceiver, the processor and the power source are carried in a cavity integrally formed in the hard hat.
